(19) United States
(12) Patent Application Publication
(10) Pub. No.: US 2020/0079172 A1
(43) Pub. Date: Mar. 12, 2020

(54) APPARATUS FOR A PRE-TEMPERATURE ALTERATION FOR AN AUTOMOTIVE

(71) Applicant: Lorenzo Tucker, Monticello, FL (US)

(72) Inventor: Lorenzo Tucker, Monticello, FL (US)

(21) Appl. No.: 16/129,749

(22) Filed: Sep. 12, 2018

(51) Int. Cl. B60H 1/00; H02S 40/38; H02J 7/35; F25B 27/00

(52) U.S. Cl. CPC B60H 1/00264; H02S 40/38; F24F 2005/0067; B60H 1/00428; F25B 27/002; H02J 7/35

(57) ABSTRACT

A alternative energy system for a car is presented. The system has solar panel, the solar panel for harnessing the sun's energy. The solar panel utilizes the solar conversion system to convert and direct the sun's energy into electricity. A car has a solar panel attached to the top of the car and the solar panel supplies energy to the temperature control center of the car.

### FIELD OF THE INVENTION

The present invention relates generally to automotive temperature control, and more particularly to an alternative energy automotive.

### BACKGROUND

Conventionally, there has been known an air-condition remote control system which enables a vehicle user to start an air conditioner of a vehicle in advance before getting into the vehicle through remote control, to thereby perform pre-air-conditioning of the vehicle cabin. For example, in one proposed system, an instruction for operating an air conditioner of a vehicle is transmitted from a cellular phone to an onboard monitor apparatus via a base station.

Upon receipt of the operation instruction, the onboard monitor apparatus determines whether or not the voltage of an onboard battery is equal to or higher than a predetermined voltage at or above which the air conditioner can operate. When the voltage of the onboard battery is equal to or higher than the predetermined voltage, the onboard monitor apparatus operates the air conditioner. Subsequently, the onboard monitor apparatus provides the cellular phone with information representing whether or not the air conditioner has started its operation.

### BRIEF DESCRIPTION OF THE DRAWINGS

FIG. 1 is a view of an automobile equipped with a solar panel.

FIG. 2 is a exemplary view the dashboard of an automobile.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

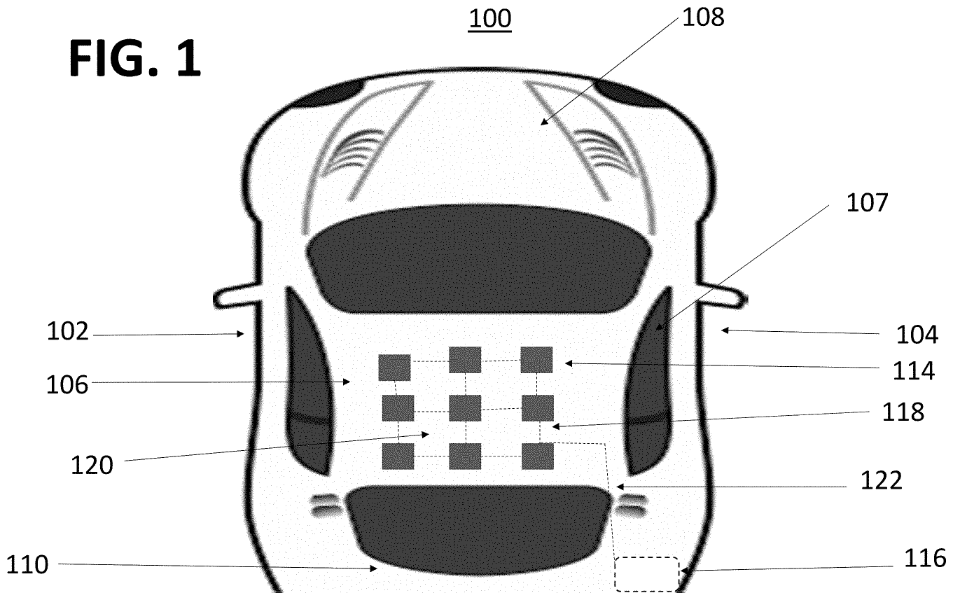

Referring now to FIG. 1, an automobile is presented which has an alternative energy source. The automobile 100 is a motor vehicle that millions of people throughout the world utilize every day. The automobile 100 is shown as a car but may be any type of motorized vehicle such as a van, a truck, a semi-truck, an electric car, etc.

The automobile 100 runs on a typical energy source. The energy source is a battery which stores the electrical energy which is used to power the different applications throughout the automobile 100. The energy source of the automobile 100 is complex and has an alternator and other mechanism to ensure that the energy source is charged to provide electrical power throughout the automobile 100.

The automobile 100 is powered typically by gasoline or diesel which are combustible and through the pistons the gasoline is ignited and the automobile 100 engine engages the power to be directed to the wheels and other systems to move the car. The power from the engine is also used to help recharge the battery.

Some automobiles 100 are electric and the energy stored in batteries is used to power not only the applications in the car, the lights, etc., but also is used to power the engine. The electric automobile 100 requires more robust systems to ensure that the battery is charged to power the automobile 100.

The automobile 100 has sides 102, 104, a top 106, an interior 107, a front hood 108 and a back hatch 110. The top 106 of the automobile 100 has a solar panel 112. The solar panel is shown as more than one panel 114 which collects the sun's energy through the sun's rays. The energy of the sun is collected at the more than one panel and is directed to a solar conversion system 116.

The solar conversion system 116 receives the collected energy from the more than one solar panel 114 and converts the energy into electricity. The solar conversion system 116 may be any type of converter system such as a generator, a converter, etc.

The solar panel 114 is coupled to the solar conversion system 116 by connectors 118. The connectors 118 connect each of the solar panels 114 to each other to form a grid 120. The grid of the solar panels 114 is coupled to the solar conversion system 116 by a system connector 122. The system connector 122 may be any type of connector which can securely carry the energy collected by the solar panels 114. This system connector may be a wire, a cable, etc.

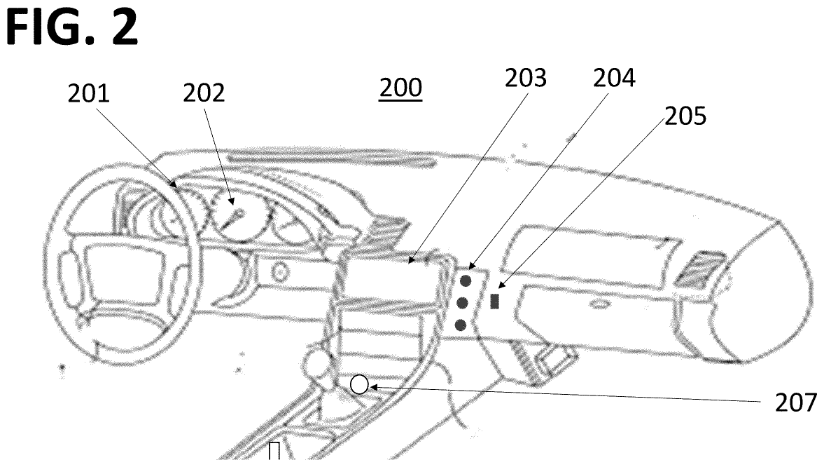

Turning now to FIG. 2, a dashboard 200 is shown. The dashboard 200 is placed in the interior 107 of the automobile 107. The dashboard 200 contains the essential gauges and applications of the automobile 100. The dashboard 200 has a speedometer 201, a RPM gauge 202, a display panel 203, more than one control button 204, a temperature switch 205, etc.

The solar conversion system 116 converts the energy collected by the solar panels 114 and stores the power in a battery, not shown. The solar conversion system 116 may also direct the electricity generated to a specific application or device. The specific application or device, may be a second battery, a cigarette lighter 207, a USB hub 208, the display panel 203, etc.

A sensor, not shown, may be set to a threshold value such that when a temperature has exceeded the threshold value, the air conditioning system is activated to provide cooling to the interior 107 of the automobile 100. The energy is supplied via the solar panels 114 and solar conversion system 116.

The sensor, not shown, may also be set for a threshold for lowest allowable temperature. When the lowest allowable temperature threshold is eclipsed then the energy from the solar panels 114 and the solar conversion system 116 is used to activate a heating system that will make the interior 107 of the automobile warm and the users will enter a comfortable automobile.

Though the use of this solar panels 114 and solar conversion system 116 are explained for the temperature control aspects of a vehicle, this system could be useful in various other aspects of the automobile that are not explicit in this application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A alternative energy system, the system comprising, the cooling system comprising:
a solar panel, the solar panel for collecting the sun's energy;
a solar conversion system, the solar conversion system for converting the energy collected by the solar panel into electricity;
a car, where the car having a top and an interior;
the solar panel coupled to the top of the car; and
the solar panel supplying the car with energy to a temperature control system.

2. The alternative energy system of claim 1, wherein when energy supplied to the temperature control system, the air-conditioning system is activated when the temperature of the interior of the car has exceeded a first threshold.

3. The alternative energy system of claim 1, wherein when energy supplied to the temperature control system, the heating system is activated when the temperature of the interior of the car is below a second threshold.

4. The alternative energy system of claim 1, wherein the solar panel supplies energy to recharge a battery.

5. The alternative energy system of claim 1, wherein the car has built-in apps.

6. The alternative energy system of claim 5, where the built-in apps are activated by energy supplied by the solar conversion system.

7. The alternative energy system of claim 1, wherein the car further comprising a display panel.

8. The alternative energy system of claim 7, wherein the display panel is activated by energy supplied by the solar conversion system.

9. The alternative energy system of claim 1, further comprising a second solar conversion system.

10. The alternative energy system of claim 9, wherein the second solar conversion system supplies energy to a different receiver than the first solar conversion system.

11. The alternative energy system of claim 9, wherein the second solar conversion system supplies energy to a same receiver than the first solar conversion system.
